(19) United States
(12) Patent Application Publication
(10) Pub. No.: US 2025/0258380 A1
(43) Pub. Date: Aug. 14, 2025

(54) Heads-up Display Apparatus for use During a Smoke Emergency

(71) Applicants: Christian WERJEFELT, Kaneohe, HI (US); Alexander WERJEFELT, Kamuela, HI (US)

(72) Inventors: Christian WERJEFELT, Kaneohe, HI (US); Alexander WERJEFELT, Kamuela, HI (US)

(21) Appl. No.: 18/604,672

(22) Filed: Mar. 14, 2024

Related U.S. Application Data
(63) Continuation of application No. 16/923,185, filed on Jul. 8, 2020, now Pat. No. 12,050,323.
(60) Provisional application No. 62/872,523, filed on Jul. 10, 2019.
(60) Provisional application No. 62/883,183, filed on Aug. 6, 2019.

(51) Int. Cl. G02B 27/01; B64D 43/00

(52) U.S. Cl. CPC G02B 27/0176; B64D 43/00; G02B 27/0172; G02B 2027/0156

(57) ABSTRACT

A goggle includes an enclosure with a viewing window, the enclosure for being attached to a user's face to seal the user's eyes from smoke; and a first heads-up display and a second heads-up display disposed on an upper portion and a lower of portion of the viewing window, respectively, so that a middle portion of the viewing window is clear to give a user a clear sight line through the viewing window.

### RELATED APPLICATIONS

This is a continuation application of application Ser. No. 16/923,185, filed Jul. 8, 2020, which claims the priority benefit of nonprovisional application Ser. Nos. 62/872,523, filed Jul. 10, 2019, and 62/883,183, filed Aug. 6, 2019, hereby incorporated by reference.

### FIELD OF THE INVENTION

The present invention is generally directed to a system to enable an operator to maintain visual contact with instruments or other visual sources of data after smoke and/or particulate from a fire or other sources has invaded the operator's environment. In particular, the present invention relates to providing a display in front of a user to provide a clear view of the instrument panel, thereby providing a pilot with vital information for guiding the aircraft to a safe landing after smoke and/or particulate matter invades the cockpit area.

### BACKGROUND OF THE INVENTION

When cockpits are invaded by continuous, dense, blinding smoke that turn airplanes into unguided missiles, the results are well known to be catastrophic and fatal for passengers and crew. None creates an unsafe condition faster than a pilot blinded by continuous, opaque smoke. And none occurs as frequently as smoke in the cockpit. According to the Air Line Pilots Association, airliners make an unscheduled or emergency landing due to smoke in the cockpit on an average of once per day.

What is true for a cockpit is equally true for any operator station where the operator's ability to see the instrument panel when smoke invades the operator's station depends on the safe operation or orderly shutdown of critical processes, such as occur in a nuclear power station, submarine and similar operator stations.

The present invention is related to U.S. Pat. No. 9,914,546, hereby incorporated herein by reference.

### SUMMARY OF THE INVENTION

The present invention provides a goggle, comprising an enclosure with a viewing window, the enclosure for being attached to a user's face to seal the user's eyes from smoke; and a first heads-up display and a second heads-up display disposed on an upper portion and a lower of portion of the viewing window, respectively, so that a middle portion of the viewing window is clear to give a user a clear sight line through the viewing window.

### BRIEF DESCRIPTION OF THE DRAWINGS

FIG. 1 is a perspective view of a goggle with a heads-up display apparatus shown in an operative position.

FIG. 2 is a side view of the goggle of FIG. 1.

FIG. 3 is a side view of the goggle of FIG. 1, showing the heads-up apparatus rotated away from the goggle.

FIG. 4 is a perspective view of FIG. 3.

FIG. 5 is a front perspective view of the heads-up apparatus.

FIG. 6 is a top view of FIG. 5.

FIG. 7 is rear perspective view of FIG. 5.

FIG. 8 is a top view of the heads-up apparatus with a cap removed to show the heads-up displays disposed inside the enclosure.

FIG. 9 is a perspective view of FIG. 8.

FIG. 10 is a front view of FIG. 1.

FIG. 11 is a perspective view of a goggle with heads-up displays integrated inside the goggle.

FIG. 12 is a rear view of the goggle of FIG. 11.

FIG. 13 is a perspective view of a goggle with a heads-up display incorporated to the outside of the goggle.

FIG. 14 is a side view of the goggle of FIG. 13.

FIG. 15 is a rear view of the goggle of FIG. 13.

FIG. 16 a perspective view of a goggle with a heads-up display apparatus shown in a non-operative position and fixedly attached to the goggle.

### DETAILED DESCRIPTION OF THE INVENTION

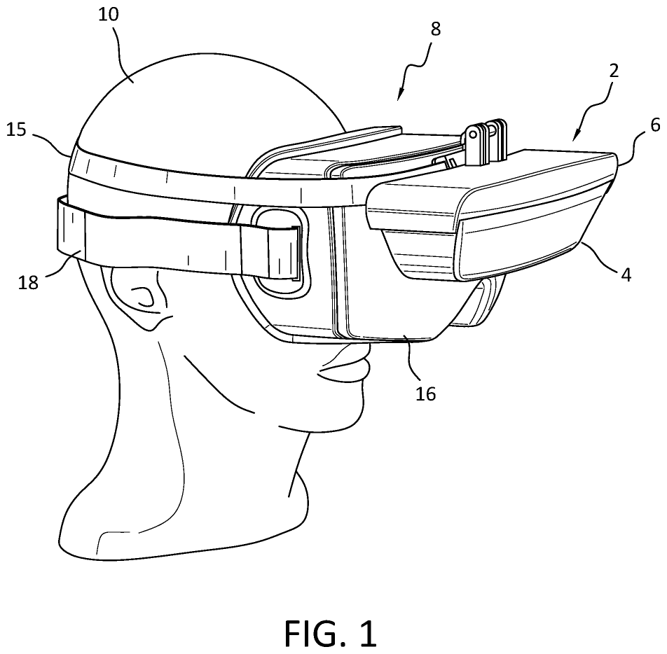

A heads-up display apparatus embodying the present invention is shown in FIG. 1. The heads-up display apparatus includes an enclosure or housing 2, including a housing portion 4 and a cap 6. Parts of the housing portion 4 is transparent. The cap 6 may be opaque. The housing 2 is preferably made of rigid material, such as plastic, metal, etc. The housing 2 is preferably removably attached to a standard facemask or goggle 8 that is worn by a user 10 during a smoke emergency. The goggle 8 is shown as a single lens goggle, but it should be understood that the goggle 8 may also include a pair of lenses, in which case it is referred to as a pair of goggles. The goggle 8 is worn by the user during an emergency to enclose and seal the user's eyes from the outside to protect the eyes from the smoke. The google 8 is understood to define an enclosure when worn by the user.

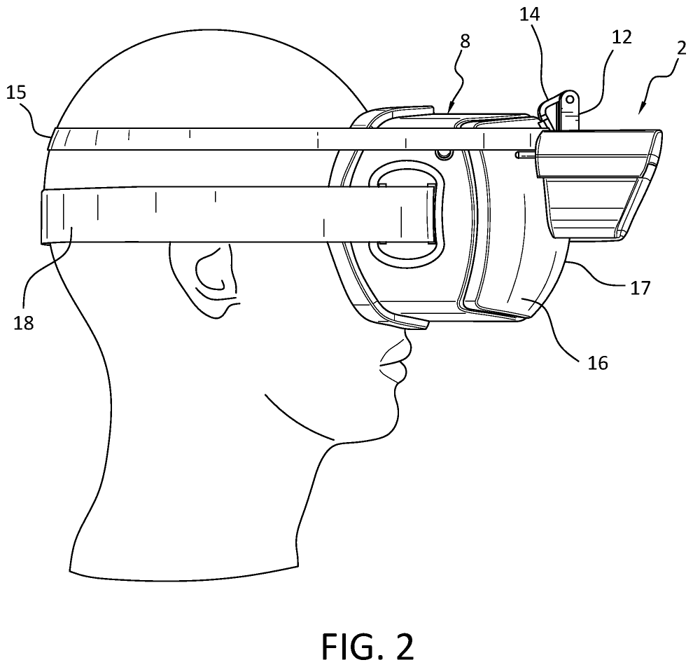

The housing 2 is preferably separate from the goggle 8 so that the housing 2 may be attached to the goggle 8 only when needed and detached when not needed. The goggle 8 includes a transparent viewing window 16 and a strap 18 for securing the goggle 8 to the user. The housing 2 has a strap 15 for removably attaching the housing 2 to the goggle 8. The strap 15 is operably attached the bracket 14 and placed around the user's head to pull the enclosure 2 against the viewing window 16 of the goggle 8. Other standard means for removably attaching the housing 2 to the goggle 8 may be used. The viewing window 16 may have a curved outside surface 17 (see FIG. 2). The transparent parts of the housing portion 4 is in line with the line of sight of the user through the viewing window 16. The housing 2 is preferably sealed from the outside environment to prevent smoke from entering the interior space of the housing.

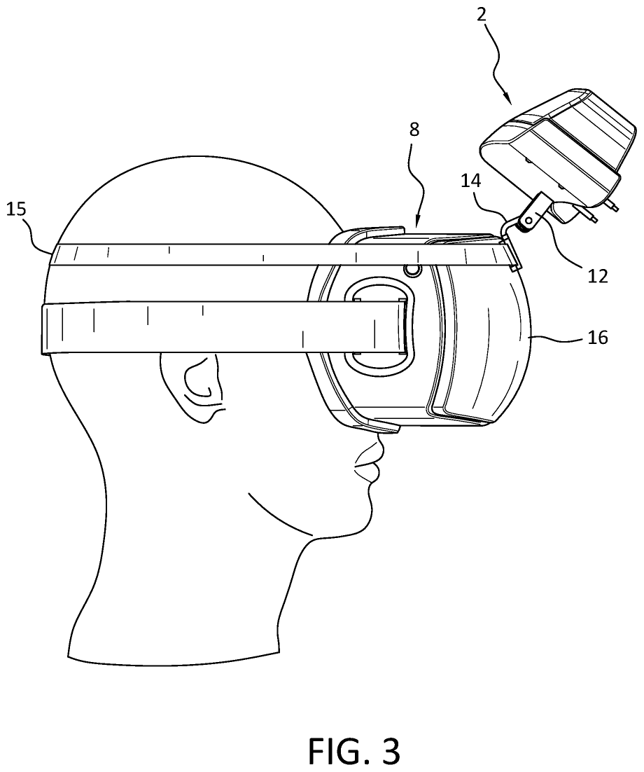

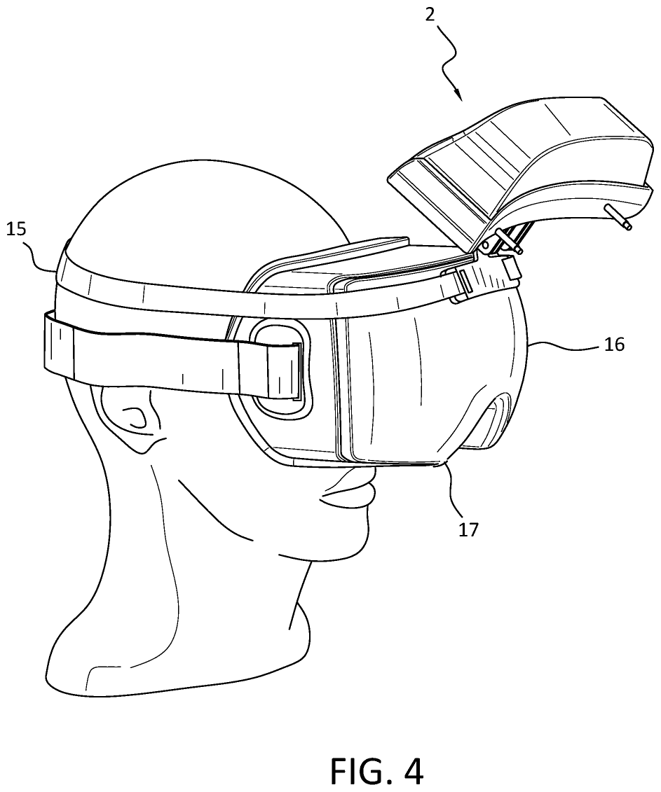

Referring to FIGS. 2, 3 and 4, the housing 2 includes a bracket 12 pivotally attached to another bracket 14, which is attached to the goggle 8 with the strap 15. The brackets 12 and 14 advantageously allow the user to position the housing 2 away from the viewing window 16 to give the user clear sight line through the viewing window 16 when emergency conditions have abated, allowing the user to see through the window 16 normally. The brackets 12 and 14 provide a hinged connection between the goggle 8 and the enclosure 2.

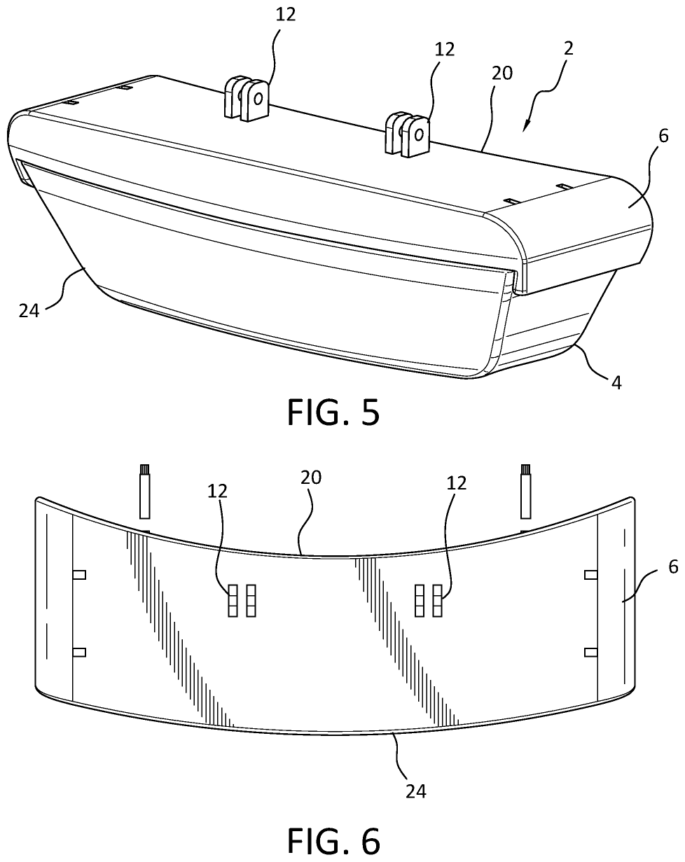

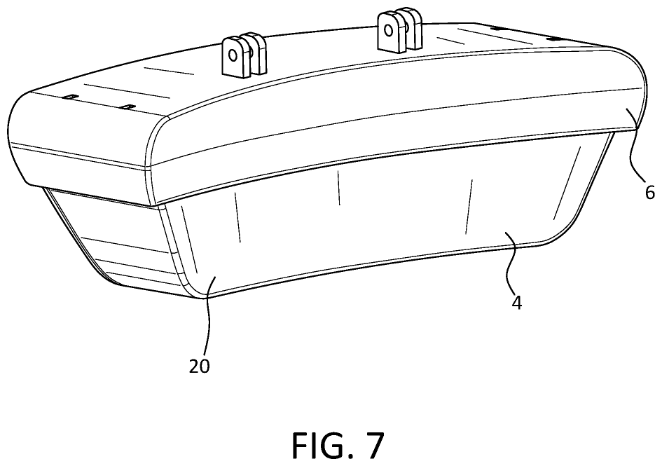

Referring to FIGS. 5-7, the housing portion 4 includes a proximal transparent wall 20 adjacent to the viewing window 16 and a distal wall 24 away from the viewing window 16. The distal wall 24 may be opaque or transparent. The wall 20 may be curved to conform to the exterior surface 17 of the viewing window 16. In this manner, any gap between the viewing window 16 and the wall 20 may be reduced so that smoke would not reduce the visibility of the heads-up display inside the housing 2. The wall 20 is disposed adjacent to the viewing window 16 during use in an emergency.

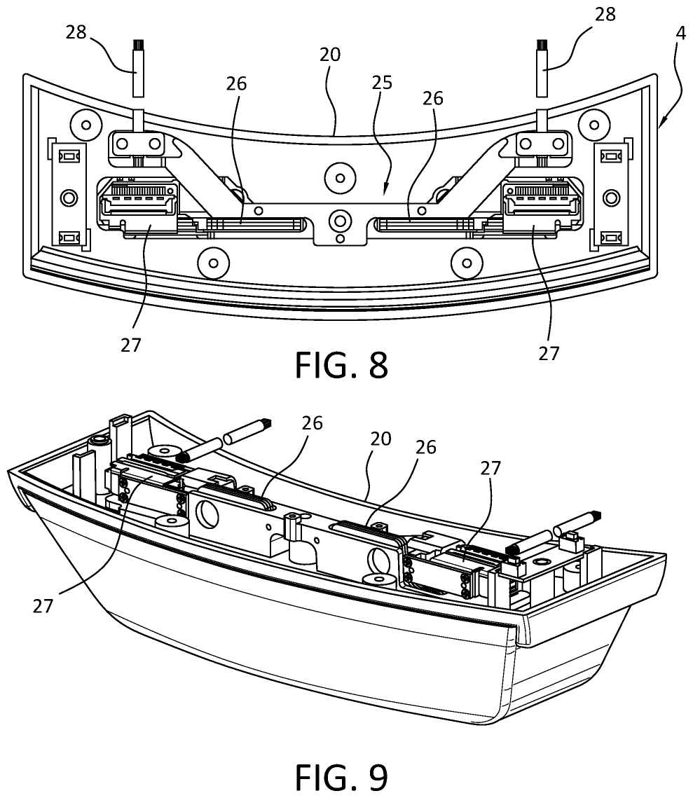

Referring to FIGS. 8 and 9, the cap 6 is removed to show a pair of standard heads-up display assemblies 25 with respective heads-up displays 26 and projectors 27 inside the housing portion 4. Although a pair of heads-up display 26 are shown, it should be understood that a single heads-up display may be sufficient to display the information required by the user by toggling between sources of information to be displayed. The display 26 may be a transparent screen made of glass or plastic, etc. that puts critical information in front of the user, so he can keep his head “up” instead of looking down or sideways to view it. Cables 28 provide signals from a source of information, such as an instrument panel, cameras pointed outside the cockpit to show the surrounding terrain, etc. for display in the heads-up displays 26. The cables 28 also provide power to the heads-up display assemblies 25.

An image is reflected from the heads-up displays 26 to the user. The user sees the image as if located in the far field in front of him. The heads-up display assembly 25 disclosed is only for illustration purposes and is not limited to what is specifically shown, as several heads-up displays are available from several manufacturers. An example of a commercial heads-up display is made by WaveOptics Inc., 1240 Rosecrans Avenue, #120 Manhattan Beach, CA 90266, enhancedworld.com. Other heads-up display manufacturers include Digilens, Sunnyvale, CA, digilens.com and dreamworldvision.com.

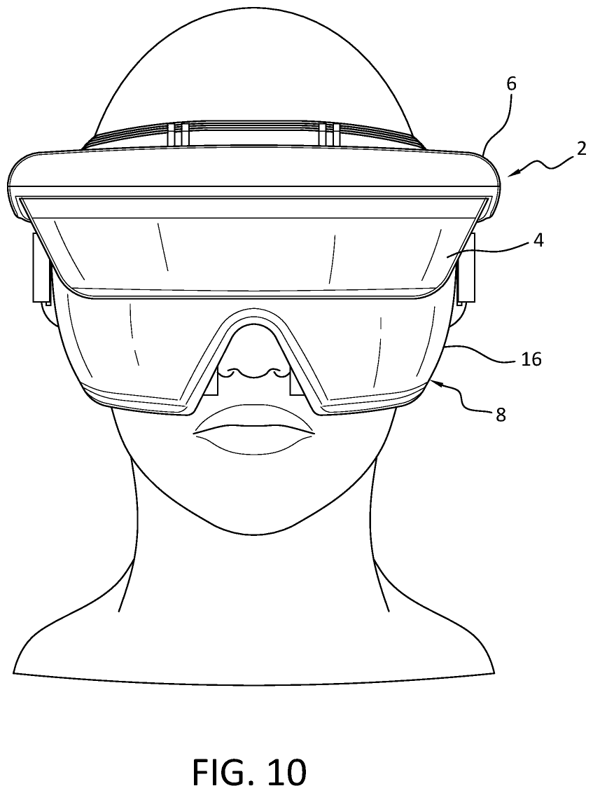

Referring back to FIGS. 1, 2 and 10, the housing 2 is shown in the operative position. When so deployed, the heads-up displays 26 shown in FIGS. 8 and 9 are understood to be disposed directly in the line of sight of the user. The enclosure 2 and the heads-up displays 26 disposed inside the enclosure are referred to as a heads-up display apparatus.

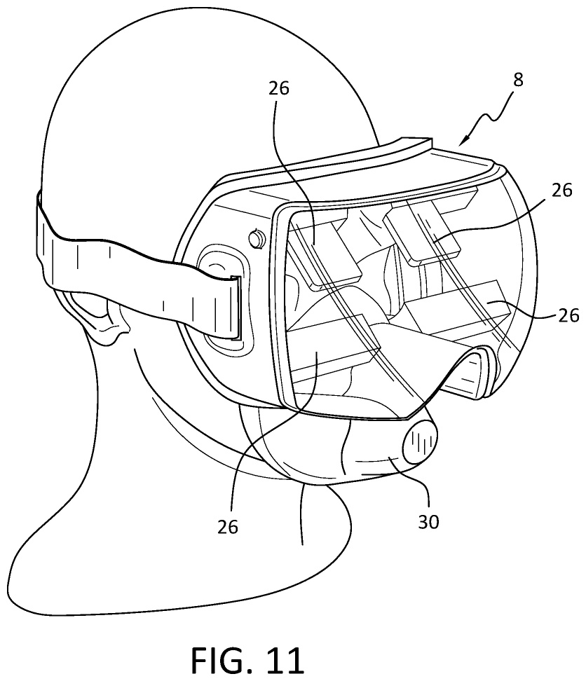

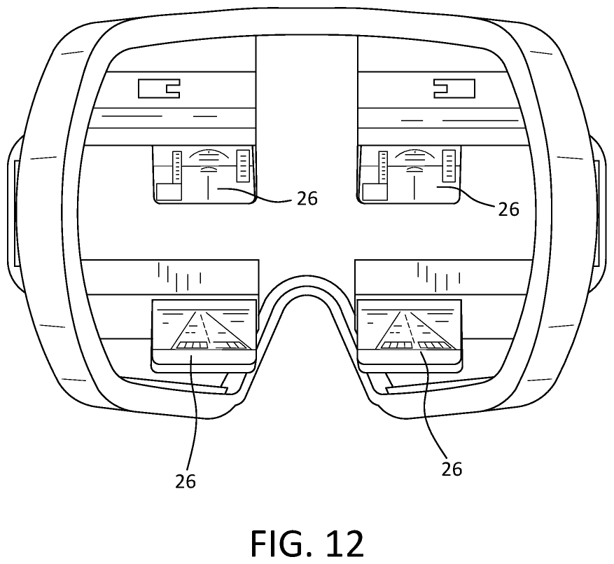

Referring to FIGS. 11 and 12, the heads-up display 26 may be incorporated into the goggle 8. The goggle 8 is shown with an oxygen mask 30. The displays 26 are disposed inside the goggle 8 in the line of sight of the viewing window 16. The placement of the displays 26 inside the goggle 8 advantageously prevents the smoke from the outside from degrading the image on the displays 26. The upper displays may be used to display outside views of the cockpit windshield. The lower displays 26 may be used to display information from the instrument panel. Although several displays are shown, a single display 26 may be sufficient to display the information needed by the user by toggling between the sources of information to be displayed.

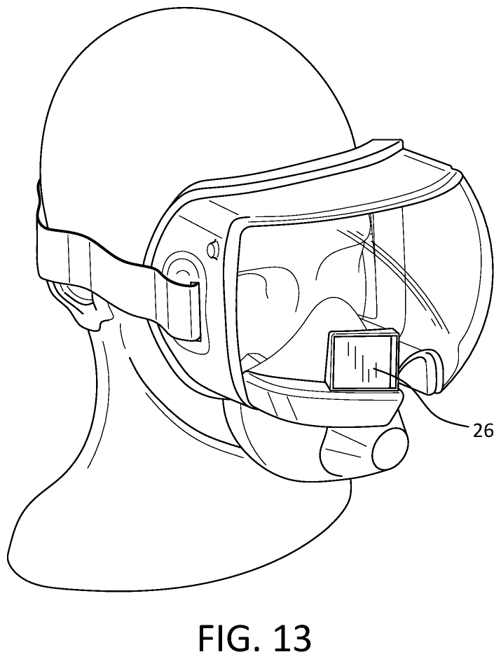

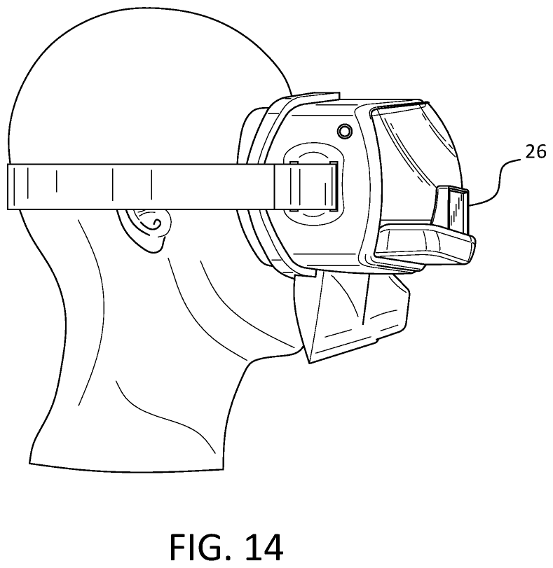

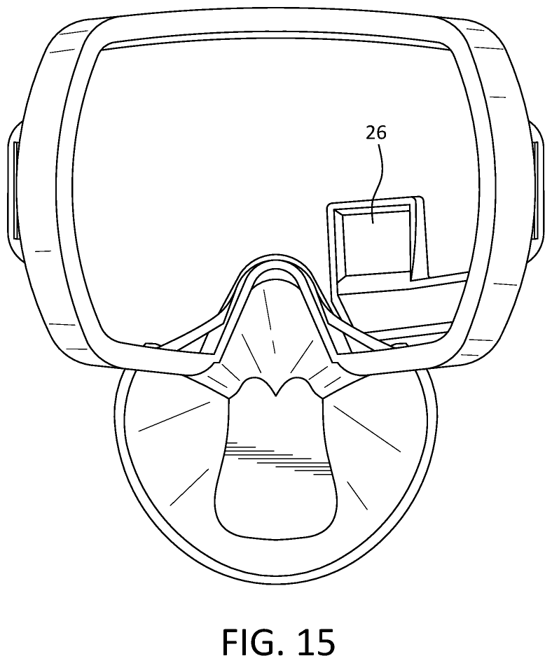

Referring to FIGS. 13-15, the heads-up display 26 may also be incorporated into the goggle 8 in the line of sight of the viewing window 16. The display 26 is shown outside the goggle 8 in close proximity to the viewing window 16. The heads-up display 26 may be sealed to the viewing window 16 to prevent smoke from coming between the viewing window 16 and the heads-up display 26 and thus degrade the image reflected to the user. Several sources of information may be displayed one at a time on the single display by toggling between the sources of information.

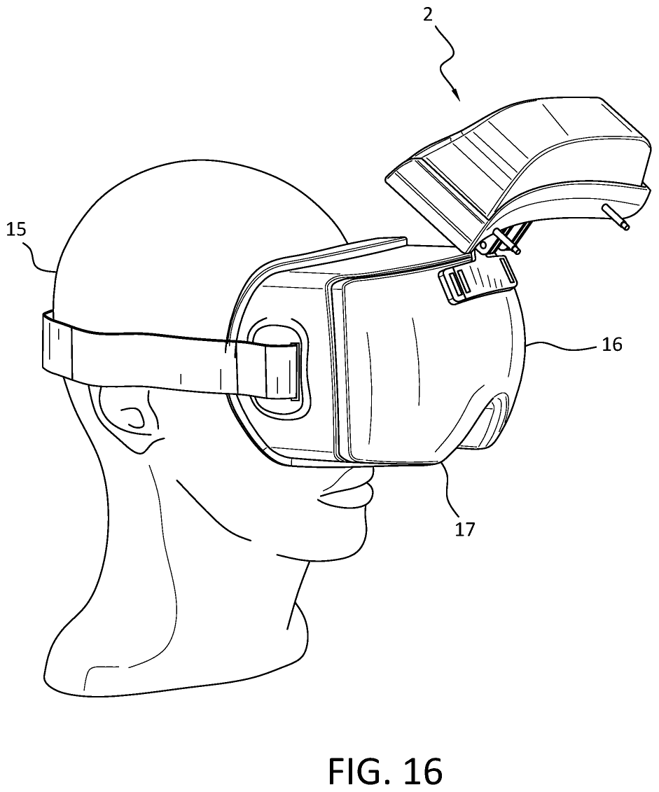

Referring to FIG. 16, the housing 2 may be fixedly attached to the goggle 8 without using the strap 15. The bracket 14 may be attached to the google 8 by any standard means, such as with adhesives or screws. Although shown attached to the viewing window 16, it should be understood that the housing 2 may also be attached to other parts of the goggle 8 using the bracket 14 or any standard means. By attaching the housing 2 directly to the goggle 8, the user only has to put on one unit during a smoke emergency to be able to see critical information to operate the aircraft safely. The brackets 12 and 14 advantageously allows the user to pivot the housing 2 away from the goggle 8 when the smoke emergency has ceased.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

We claim:

1. A goggle, comprising:
a) an enclosure including a viewing window, the enclosure for being attached to a user's face to seal the user's eyes from smoke; and
b) a first heads-up display and a second heads-up display disposed on an upper portion and a lower of portion of the viewing window, respectively, so that a middle portion of the viewing window is clear to give a user a clear sight line through the viewing window.

2. The goggle as in claim 1, and further comprising a third heads-up display and a fourth heads-up display disposed on another upper portion and another lower portion of the viewing window, respectively, so that a middle portion of the viewing window is clear to give a user a clear sight line through the viewing window.

3. The goggle as in claim 2, wherein the first, second, third and fourth heads-up displays are disposed inside the enclosure.
